(19) United States
(12) Patent Application Publication
(10) Pub. No.: US 2022/0362897 A1
(43) Pub. Date: Nov. 17, 2022

(54) COVER FOR A HAMMER TOOL AND SYSTEMS, ASSEMBLIES, AND METHODS THEREOF

(71) Applicant: Caterpillar Inc., Peoria, IL (US)

(72) Inventors: Cody MOORE, Lorena, TX (US); Manoj KUMAR, Bangalore (IN); Akshay D. MATE, Pune (IN); Hariom K. GUPTA, Chennai (IN); Chetan V. DAHIWAL, Chennai (IN)

(73) Assignee: Caterpillar Inc., Peoria, IL (US)

(21) Appl. No.: 17/317,895

(22) Filed: May 12, 2021

(51) Int. Cl. B23Q 11/08

(52) U.S. Cl. CPC B23Q 11/085; B25D 2222/72; B25D 17/26

(57) ABSTRACT

A cover for a hammer tool and systems, assemblies, and methods thereof can be flexible and can comprise a body; a first attachment interface at a first end portion of the body; and a second attachment interface at a second end portion of the body separated from the first end portion of the body. A predefined hinge can be formed in the body of the cover, between the first attachment interface and the second attachment interface. The cover can be configured to be fixedly coupled to a housing of a hammer tool via the first attachment interface. The cover can be configured to be removably coupled to the housing of the hammer tool via the second attachment interface.

### TECHNICAL FIELD

The present disclosure relates to hammer or breaker tools, and more particularly to covers for hammer tools, and systems, assemblies, and methods thereof.

### BACKGROUND

A hammer or breaker tool may be used in mining applications to break rock boulders. The hammer tool may include a power cell having mounted thereon an automatic lubrication (“auto-lube”) system to provide lubrication to the hammer tool. The power cell may be provided inside a housing of the hammer tool, where a pocket in the housing may provide access to the auto-lube system, for instance, for grease cartridge refilling, servicing, etc. An access door may be provided over the pocket. Conventionally, such access door may be implemented by way of a plate bolted to the housing to cover the pocket. However, use of bolts to fasten the plate to the housing to cover the pocket may result in reluctance from the user to reinstall the plate once access is no longer needed. The failure to replace the access door back over the pocket once access is no longer needed may result in dust and other foreign elements gaining access to inside the housing via the open pocket, which can adversely affect the hammer tool.

Korean Patent Document KR 10-2009-0052695 (“the KR '695 patent document”) describes a breaker having a protective cover drawing a hydraulic hose, installed in a front of a bracket assembly in order to protect an automatic grease injection unit. The KR '695 patent document describes that the protective cover is provided so that an upper portion can be attached or detached, once mounting bolts are removed, according to rotation about a hinge fastened via a fastening bolt. However, to open the protective cover the mounting bolts must be removed.

### SUMMARY

According to an aspect a flexible cover for a hammer tool is disclosed or provided. The flexible cover for the hammer tool can comprise: a body; a first attachment interface at a first end portion of the body; and a second attachment interface at a second end portion of the body separated from the first end portion of the body. A predefined hinge can be formed in the body between the first attachment interface and the second attachment interface. The flexible cover can be configured to be fixedly coupled to a housing of a hammer tool via the first attachment interface. And the flexible cover can be configured to be removably coupled to the housing of the hammer tool via the second attachment interface.

In another aspect, a flexible cover for a breaker tool is disclosed or provided. The flexible cover for the breaker tool can comprise: first coupling means for fixedly coupling a first end portion of the flexible cover to a housing of the breaker tool; second coupling means for removably coupling a second end portion of the flexible cover to the housing of the breaker tool; gripping means for manually gripping the flexible cover when the flexible cover is provided over an access opening in the housing of the breaker tool; and moving means for moving a second portion of the flexible cover relative to a first portion of the flexible cover. The first portion of the flexible cover can include the first end portion of the flexible cover.

And in another aspect a hammer tool assembly is disclosed or provided. The hammer tool assembly can comprise: a housing having an aperture to access an interior of the housing; and a flexible, non-metallic cover configured to be fixedly and removably coupled to the housing, over the aperture of the housing, to prevent access to the interior of the housing in a closed state of the cover and to allow access to the interior of the housing in one or more open states of the cover. The cover can include: a body, a first attachment interface to fixedly couple to the housing a first end portion of the body, a second attachment interface to removably couple to the housing a second end portion of the body opposite the first end portion of the body, a grip provided on a front side of the body, the grip being offset inward relative to a periphery of the body, and a hinge built into the body between the grip and the first attachment interface.

Other features and aspects of this disclosure will be apparent from the following description and the accompanying drawings.

### BRIEF DESCRIPTION OF DRAWINGS

FIG. 1 is a perspective view of a hammer or breaker tool assembly according to one or more embodiments of the disclosed subject matter.

FIG. 2 is a perspective view of the hammer or breaker tool assembly of FIG. 1 with a cover according to one or more embodiments of the disclosed subject matter removed.

FIG. 3 is a front perspective view of a cover for a hammer tool assembly according to one or more embodiments of the disclosed subject matter.

FIG. 4 is a rear perspective view of the cover of FIG. 3.

FIG. 5A and FIG. 5B are side elevational views of covers for hammer tool assemblies according to embodiments of the disclosed subject matter.

FIG. 6 is an elevational view of an upper portion of the hammer tool assembly of FIG. 1.

FIG. 7 is a top perspective view of an upper portion of the hammer tool assembly of FIG. 1.

FIG. 8 is an enlarged side sectional view of an upper portion of the hammer tool assembly of FIG. 1.

### DETAILED DESCRIPTION

Embodiments of the disclosed subject matter relate to hammer or breaker tools, and more particularly to covers for hammer tools, and systems, assemblies, and methods thereof.

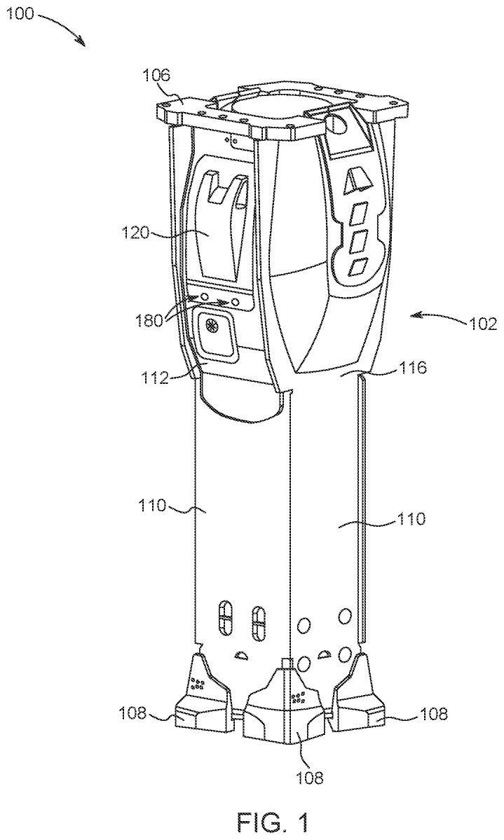

FIG. 1 is a perspective view of a hammer or breaker tool assembly 100 according to one or more embodiments of the disclosed subject matter. The hammer tool assembly 100 can comprise a housing 102 and a mounting bracket 106 at a first end of the housing 102 to connect the hammer tool 100 to a linkage of a corresponding machine, such as an excavator. One or more rock claws 108 may be provided at a second end of the housing 102 opposite the first end of the housing 102. A hammer or breaker tool may operatively extend from the second end of the housing 102 of the hammer assembly 100.

The housing 102, which may optionally taper from thick to thin at least at an upper portion thereof (from the area of mounting bracket 106 in the direction toward rock claws 108), can include a plurality of sidewalls 110. Optionally, each of the sidewalls 110 can extend in one piece from the top of the housing 102 to the bottom of the housing 102, i.e., the first and second ends, respectively. Hence, no weld portions may be provided along the length of each sidewall 110 (though according to one or more embodiments adjacent sidewalls 110 can have edges welded together to form corners of the housing 102). The tapering profile for the housing 102 can help to concentrate stress to more robust areas of the housing 102.

A plurality of panels may also be provided, including a first panel 112 and a second panel 116. According to one or more embodiments, the first panel 112 and the second panel 116 may be rereferred to as a front panel and a side panel, respectively. The second panel 116 can cover one or more underlying openings or apertures, for instance, through which components of the hammer tool assembly 100, such as a pressure control valve (PCV) to adjust pressure, accumulator, return and/or supply hydraulic connections, etc., can be accessed.

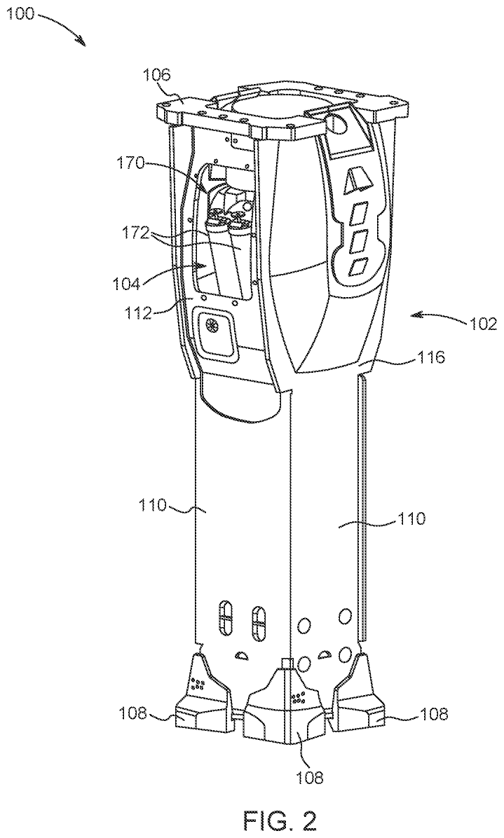

A cover 120 can be provided on the first panel 112. Generally, the cover 120 can be provided over a portion of an auto-lube system 170 provided within the housing 102, for instance, within a pocket of the housing 102. More specifically and referring also now to FIG. 2, the cover 120 can be provided over an opening or aperture 104 to allow or prevent access to the portion of the auto-lube system 170. The portion of the auto-lube system 170 accessible via the aperture 104 can be or include one or more lubrication (e.g., grease) cartridges 172, for instance. The aperture 104 geometry may be based on the geometry of the cover 120 or vice versa. According to one or more embodiments, the aperture 104 can be square-shaped or rectangular.

Thus, according to one or more embodiments, access to the interior of the housing 102 by unwanted material such as dirt via the aperture 104 can be prevented when the cover 120 is closed or fully over the aperture 104, such as shown in FIG. 1. Likewise, access inside the housing 102 via the aperture 104 can be afforded when the cover is removed, for instance, fully removed as shown in FIG. 2 or partially removed (discussed in more detail below). The partial removal of cover 120 may be referred to or characterized as opening the cover 120 and cover 120 can be partially removed or opened enough to gain access to inside the housing 102 via the aperture 104, for instance, to service the auto-lube system 170, particularly the cartridges 172 or associated components thereof.

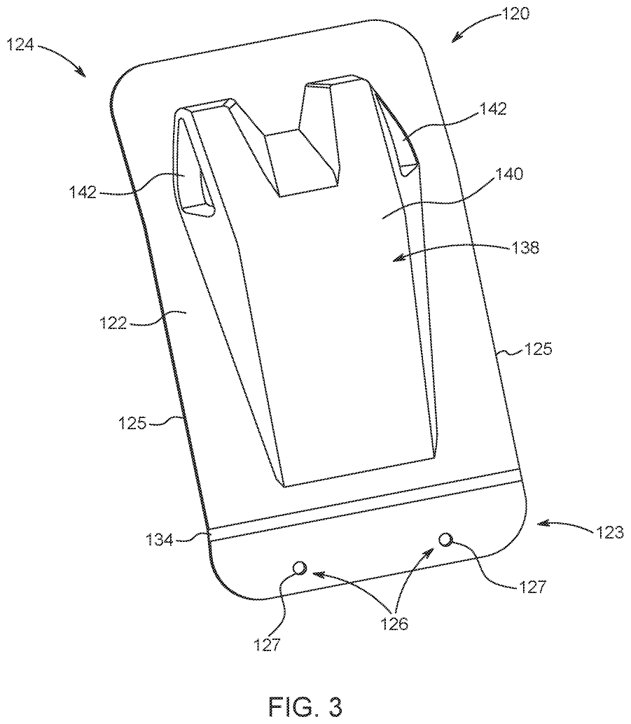

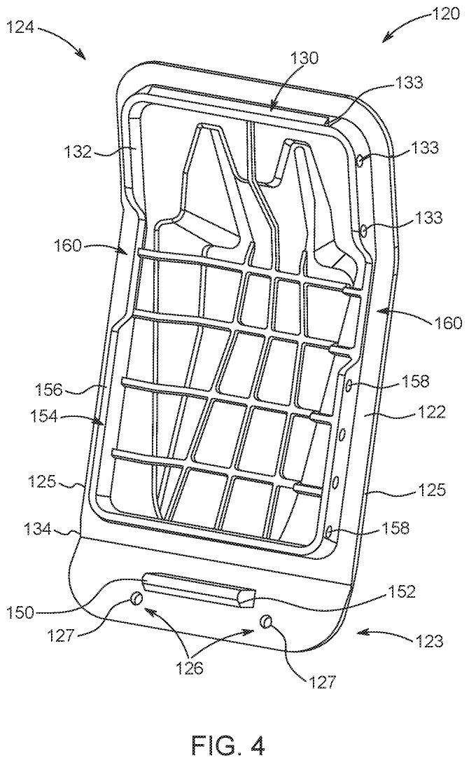

Turning now to FIG. 3 and FIG. 4, these figures respectively show first and second views of the cover 120. The views shown in FIG. 3 and FIG. 4 may be referred to as front and rear views, respectively.

The cover 120, which can be formed in one piece, for instance, by molding (e.g., compression molding, injection molding, etc.), can be flexible at least at one or more predefined locations. According to one or more embodiments, the cover 120 can be made of a flexible material, for instance, a non-metallic material such as natural or synthetic rubber or a urethane or other non-rubber material. The view of the cover 120 shown in FIG. 3 may be referred to or characterized as showing a first or front side of the cover 120 and the view of the cover 120 shown in FIG. 4 may be referred to or characterized as showing a second or rear side of the cover 120.

Generally, the cover 120 can be configured to be fixedly and removably coupled to the housing 102 of the hammer tool assembly 100, over the aperture 104, such as shown in FIG. 1. Removably coupled may mean that a corresponding portion of the cover 120 is relatively easier to remove, i.e., decouple or disengage, from the housing 102 as compared to a portion of the cover 120 that is fixedly coupled to the housing 102. Here, easier may mean via a single hand of an individual versus removal involving one or more components other than the cover 120 (e.g., one or more fasteners 180, such as screws, retention bolts), for instance, using a disassembly tool (e.g., screwdriver, wrench). Additionally or alternatively, fixedly coupled may mean that the coupling can be retained even when one or more other portions of the cover 120 are decoupled from the housing 102.

The cover 120 can include a body 122, a first attachment interface 126, a second attachment interface 130, and a hinge 134. Optionally, the cover 120 can have a grip 138. According to one or more embodiments, the cover 120 can have a length or height greater than a width, such as shown in FIG. 3 and FIG. 4. Also shown in FIG. 3 and FIG. 4, the first attachment interface 126 can be at a first end portion 123 of the body 122 (or cover 120) and the second attachment interface 130 can be at a second end portion 124 of the body 122 (or cover 120).

The first attachment interface 126 can serve to fixedly couple the first end portion 123 of the body 122 (or cover 120) to the housing 102, for instance, to the first panel 112. The first attachment interface 126 may implement a so-called positive mounting configuration. Such positive mounting configuration may include one or more openings 127 through the body 122 to receive respective one or more fasteners 180 to couple the first end portion 123 of the body 122 (or cover 120) to the first panel 112. The fasteners 180 may be screws or retention bolts, as examples. Here, FIG. 3 and FIG. 4 show two openings 127 as part of the first attachment interface 126, though embodiments of the disclosed subject matter are not so limited. Optionally, the first attachment interface 126 can be centered (including symmetrically provided) at the first end portion 123 of the body 122 (or cover 120) relative to opposing edges 125 of the body 122. According to one or more embodiments, a plate (e.g., a metal plate) may go over the top of the opening(s) 127 of the first attachment interface 126 and also receive the one or more fasteners 180, such that the plate sandwiches the cover 120 against the first panel 112.

The second attachment interface 130 can serve to removably couple the second end portion 124 of the body 122 (or cover 120) to the housing 102, for instance, to the first panel 112. The second attachment interface 130 can include one or more projections 132, for instance, flanges, extending from the body 122 on the second (or rear) side of the cover 120. Each projection 132 can interface with the underlying first panel 112 to removably couple the second end portion 124 of the body 122 (or cover 120) to the housing 102. For instance, FIG. 4 shows a single projection or flange 132.

The projection 132 can be offset inward relative to a periphery of the body 122. Thus, the body 122 may have a portion that extends outward in the length and/or width direction past the projection 132. In some respects, such extending portions may be considered or characterized as a lip or ledge.

According to one or more embodiments, the projection 132 can take the shape of a sidewall of the first panel 112 forming the aperture 104. For instance, the projection 132 shown in FIG. 4 is shown as a U-shaped flange 132 (upside down), because the shape of the corresponding portion of the aperture 104 is U-shaped (upside down). Thus, according to one or more embodiments, the projection 132 of the second attachment interface 130 can have an end portion and/or side or edge portions, such as shown in FIG. 4, that may conform to one or more portions of the aperture 104. Optionally, the transition from the end portion to the side/edge portions may be rounded.

One or more tabs 133 may extend from an outer sidewall of the projection 132. For instance, FIG. 4 shows tabs 133 provided on the sidewall of the end portion and the side/edge portions of the projection 132. However, embodiments of the disclosed subject matter are not so limited. For instance, only the tab 133 at the end portion, which may be elongate and extend along a length (entirely or partially) of the end portion of the projection 132, may be provided. Alternatively, only the tabs 133 at the side/edge portions of the projection 132 may be provided. As yet another alternative, a plurality of tabs 133 (e.g., possibly shorter in width) may be provided at the end portion and/or a single tab 133 (e.g., possibly longer in width) may be provided at each of the side/edge portions of the projection 132. In any event, in the case of multiple tabs being provided, the tabs 133 may be scattered or separated from one another, such as shown in FIG. 4.

The one or more tabs 133 can provide a positive locking feature with respect to the aperture 104 and surrounding sidewall of the first panel 112 forming the aperture 104. That is, each tab 133, due to its shape, can frictionally engage and releasably lock with the surrounding sidewall of the first panel 112 when the cover 120 is removably coupled to the first panel 112. Such positive locking may be by snap-fit by way of the tab(s) 133 having shapes such that when cover 120 is pressed toward first panel 112, the tabs 133 deform inwardly and pass through opening or aperture 104, and then when the cover 120 is released the tabs 133 return to their undeformed position and shift outward to extend beyond the perimeter of opening or aperture 104, securing the cover 120 to the first panel 112.

The hinge 134 can be predefined, formed in or built into the body 122. For instance, the hinge 134 may be formed to have certain geometry to facilitate bending and hence rotation of the portion of the cover 120 between the hinge 134 and a second end of the cover 120 at the second end portion 124 about the hinge 134 relative to the portion of the cover 120 between the hinge 134 and a first end of the cover 120 at the first end portion 123. In that the hinge 134 can be formed in or built into the body 122, the hinge 134 may be referred to or characterized as a living hinge. Such living hinge 134 may not be subject to friction during operation. Portions of the cover 120 between the hinge 134 and the second end of the cover 120 at the second end portion 124 may be referred to herein as a second portion of the cover 120 and portions of the cover 120 between the hinge 134 and the first end of the cover 120 at the first end portion 123 may be referred to herein as a first portion of the cover 120.

The geometry of the hinge 134 can be a thin area, thinned in a thickness direction from one or both sides of the body 122 relative to adjacent portions of the body 122. According to one or more embodiments, the hinge 134 may extend between opposite edges 125 of the body 122, such as shown in FIG. 3 and FIG. 4. Such extending, whether from opposite edges 125 or otherwise, can be perpendicular to a length direction of the cover 120. Moreover, the hinge 134 can be provided between the first end portion 123 and the second end portion 124. Optionally, the hinge 134 may define a boundary for the first end portion 123. The hinge 134 may also be between the first attachment interface 126 and the second end portion 124. As shown in FIG. 3, for instance, the hinge 134 may also be between the grip 138 and the first end portion 123 (and the first attachment interface 126).

The rotation afforded by the hinge 134 may be in one or more directions from an initial unrotated state. For instance, the hinge 134 may provide for rotation of the portion of the cover 120 between the hinge 134 and the second end of the cover 120 in a direction of the first or front side of the cover 120 (out of the page in FIG. 3 and into the page in FIG. 4). The hinge 134 may also provide for rotation back to the initial starting point prior to the rotation. Optionally, the hinge 134 may disallow or discourage (e.g., requires more force) to rotate the portion of the cover 120 between the hinge 134 and the second end of the cover 120 in a direction of the second or rear side of the cover 120 (into of the page in FIG. 3 and out of the page in FIG. 4) from the initial starting point.

The grip 138 can be provided on the first or front side of the cover 120. Optionally, the grip 138 can be offset inward relative to a periphery of the body 122, such as shown in FIG. 3 and FIG. 4. Also shown in FIG. 3 and FIG. 4, the grip 138 can be between (in the length or height direction of the cover 120) the first end portion 123 and the second end portion 124. The grip 138 may also be between the hinge 134 and the second end portion 124 of the cover 120. Thus, according to one or more embodiments, the grip 138 may be offset or spaced from the hinge 134 in the length or height direction of the cover 120.

According to one or more embodiments, the grip 138 can extend or project from the first or front side of the cover 120, for instance, relative to the body 122. Thus, the grip 138 may be characterized as being convex or having a convex portion 140, at least relative to the first or front side of the cover 120. On the other hand, according to one or more embodiments, the grip 138 may be hollow or concave from the second or rear side of the cover 120, such as shown in FIG. 4. The convex and concave nature of the grip 138 can serve to accommodate underlying components inside the housing 102, such as the cartridge(s) 172 of the auto-lube system 170. In the example shown in FIG. 3 and FIG. 4, the grip 138 can taper along both the lengthwise direction and widthwise direction of body 122 from thick to thin in somewhat of a V-shape. In any event, the shape of the grip 138 may be based on the underlying components of the hammer tool assembly 100 that may need to be accommodated (or not) in terms of space by the convex portion 140 of the grip 138.

According to one or more embodiments, the grip 138 may have one or more inwardly concave, recessed, or indented portions 142 provided in the convex portion 140, for instance. As an example, the two inwardly concave portions 142 may be provided on opposite sides (e.g., side edges) of the convex portion 140. Such convex-concave configuration of the convex portion 140 can be to provide a positive holding feature for the cover 120. As an example, an individual may place respectively his or her index finger and thumb in the concave portions 142 to grip or otherwise handle the cover 120, though embodiments of the disclosed subject matter are not so limited. For instance, each of the concave portions 142 may be sized to accommodate more than one finger of the individual. Such handle or grip 138 may be referred to or characterized as a dual handle or grip. Moreover, such handling may include installation of the cover 120 over the aperture 104, opening and closing (fixedly coupling) the cover 120 relative to the aperture 104, and/or removing the cover 120 entirely from over the aperture 104.

According to one or more embodiments, the cover 120 may also have an extension of projection 150, for instance, a flange, extending from the body 122 on the second (or rear) side of the cover 120. The projection 150, as shown in FIG. 4, for instance, can be located between the first attachment interface 126 and the hinge 134. In this regard, the projection 150 may be considered in, at, or part of the first end portion 123 of the cover 120.

Generally, the projection 150 can help serve to retain or lock the cover 120 in place over the aperture 104, for instance, to fixedly couple the first end portion 123 of the cover 120 to the housing 102 via the first attachment interface 126 and one or more fasteners 180 (e.g., screws or retention bolts). More specifically, the projection 150 can be provided through a corresponding portion of an opening in the housing 102, particularly the first panel 112. According to one or more embodiments, the opening may be the aperture 104. Alternatively, the opening can be a separate opening from the aperture 104, for instance, a correspondingly similar sized slit or slot in the first panel 112. In any event, the projection 150 may include or have a snap-fit configuration, for instance, a so-called dual side snap configuration. This can involve a ridge 152 shaped to engage with the first panel 112, at the aperture 104, and help lock the cover 120 to the first panel 112 over the aperture 104. Moreover, the snap-fit arrangement can be implemented without removably coupling the second attachment interface 130 to the first panel 112.

Retention of the projection 150 to the first panel 112 may also be to maintain clearance between the hinge 134 and the edge of the first panel 112 to which the projection 150 is engaged. Thus, the projection 150, when retained or locked to the first panel 112, may also ensure functionality of the hinge 134.

According to one or more embodiments, a third attachment interface 154 may be provided. The third attachment interface 154 may also removably couple corresponding portions of the cover 120 to the housing 102, for instance, to the first panel 112. The third attachment interface 154 can include one or more projections 156, for instance, flanges, extending from the body 122 on the second (or rear) side of the cover 120. Each projection 156 can interface with the underlying first panel 112 to removably couple corresponding portions of the cover 120 to the housing 102. For instance, FIG. 4 shows a single projection or flange 156. The projection or flange 156 may be referred to herein as a second projection or flange, whereas the projection or flange 132 may be referred to herein as a first projection or flange.

The projection 156 can be offset inward relative to the periphery of the body 122. Thus, the body 122 may have portions that extend outward in the length and/or width direction past the projection 156. In some respects, such extending portions may be considered or characterized as a lip or ledge.

The projection 156 shown in FIG. 4 is shown as a U-shaped flange 156, though embodiments of the disclosed subject matter are not so limited. For instance, the end portion may be omitted leaving two side or edge projections 156. According to one or more embodiments, the projection 156 of the third attachment interface 154 can have side or edge portions that may conform to corresponding portions of the aperture 104. Optionally, the transition from the end portion to the side/edge portions may be rounded.

One or more tabs 158 may extend from an outer sidewall of the projection 156. For instance, FIG. 4 shows a plurality of tabs 158 provided on the sidewall of each of the side/edge portions of the projection 156. However, embodiments of the disclosed subject matter are not so limited. For instance, only one tab 158 (e.g., possibly longer in width) may be provided for each of the side/edge portions of the projection 156. The end portion of the projection 156 may not have any tabs 158, because the end portion may not interface with the side edge of the first panel 112 when the cover 120 is provided over the aperture 104.

The tabs 158 can provide a positive locking feature with respect to the aperture 104 and surrounding sidewall of the first panel 112 forming the aperture 104. That is, each tab 158, due to its shape, can frictionally engage and releasably lock with the surrounding sidewall of the first panel 112 when the cover 120 is removably coupled to the first panel 112. Such positive locking may be by snap-fit by way of the tab(s) 158 having shapes such that when cover 120 is pressed toward first panel 112, the tabs 158 deform inwardly and pass through opening or aperture 104, and then when the cover 120 is released the tabs 158 return to their undeformed position and shift outward to extend beyond the perimeter of opening or aperture 104, securing the cover 120 to the first panel 112.

As shown in FIG. 4, one or more ribs can be provided in or on the body 122 of the cover 120. Such ribs may be provided on the second or rear side of the cover 120 and may run transversely and/or longitudinally. According to one or more embodiments, the ribs may be contained within or between the second attachment interface 130 and the third attachment interface 154 in a rear elevational view of the cover 120. Ribs can, in known manner, alter the stiffness of the cover 120. Rib configurations according to embodiments of the disclosed subject matter may balance or provide relatively high strength, relatively less weight, along with suitable flexibility for the cover 120.

Still referring to FIG. 4, a pair of recesses 160 may be provided on the second or rear side of the cover 120 (and body 122). Such recesses 160 may separate the second attachment interface 130 from the third attachment interface 154. Thus, the recesses 160 can separate the flange 132 of the second attachment interface 130 from the flange 156 of the third attachment interface 154.

The recesses 160, which may be referred to as bending recesses, can define a common bending zone across variants of the size of the aperture 104. Thus, the cover 120 can be provided over differently sized apertures 104, with the recesses 160 promoting or ensuring a relatively stress-free shape change, for instance, in the event that the cover 120 needs to be bent (e.g., compressed) such that the second attachment interface 130 and the third attachment interface 154 can be suitably removably coupled to the first panel 112 such that the cover 120 appropriately covers the aperture 104. In this regard, some covers may need to be bent (e.g., compressed) to fit into the aperture 104 and other covers may not need to be bent to fit into the aperture 104, depending upon the size of the particular aperture 104. Hence, the recesses 160 may provide flexing capabilities for the cover 120 depending upon the particular size of the aperture 104 and enabling the cover 120 to be used with a range of different-sized and shaped apertures 104. That is, the recesses 160 can allow flexing of the cover 120 so the cover can be suitably fitted over the aperture 104 and/or so the cover 120 can be retained over the aperture 104 (i.e., fixedly and removably coupled over the aperture 104) even if the shape of the aperture 104 is somewhat different from the shape of the aperture 104 that the cover 120 was designed to be used with.

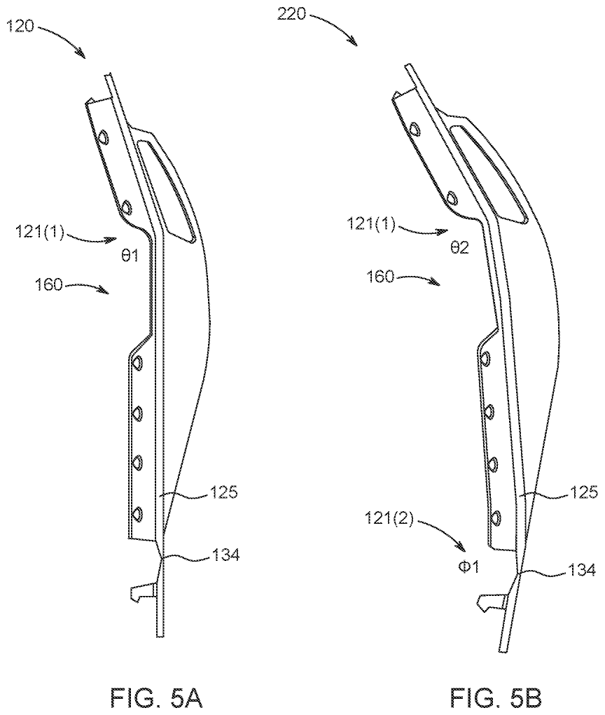

Turning now to FIG. 5A and FIG. 5B, these figures show side elevational views of covers according to embodiments of the disclosed subject matter. Here, the cover 120 is labeled for FIG. 5A and a cover 220 is labeled for FIG. 5B. The cover 120 and the cover 220, as shown in the side elevational views of FIG. 5A and FIG. 5B, respectively, can be representative of the cover 120 and the cover 220 in an unflexed state. Such unflexed state can be when either of the covers is coupled to the housing 102.

Notably, covers according to embodiments of the disclosed subject matter, such as the cover 120 and the cover 220, can be curved in the side elevational view. For instance, covers according to embodiments of the disclosed subject matter can have one or more bent portions in the body, thus, the term curved should be construed as synonymous with nonplanar, as the side edges 125 of covers 120 and 220 do not lie in a single plane. Here, each of the cover 120 and the cover 220 can have a first bent portion 121(1). The first bent portion 121(1) of the cover 120 may be at an obtuse angle θ1 and the first bent portion 121(1) of the cover 220 may be at an obtuse angle θ2 different from the obtuse angle θ1. The first bent portion 121(1) may, according to one or more embodiments, be provided at an interface where the second attachment interface 130 meets the bending recesses 160. Hence, the first bent portion 121(1) may contribute to the flexing capability of the cover 120, 220 by way of at least the recess 160.

Optionally, covers according to embodiments of the disclosed subject matter may have a second bent portion 121(2). In the example shown in FIG. 5A and FIG. 5B, the cover 120 may not be provided with the second bent portion. Thus, even though rotation of the cover 120 may occur about the hinge 134, in the unflexed state the body may not be bent at the hinge 134. On the other hand, the cover 220 can have second bent portion 121(2). Here, the second bent portion 121(2) can be at or adjacent to the hinge 134. Thus, in one or more embodiments, the hinge 134 may form one of the bent portions. The second bent portion 121(2) of the cover 220 may be at an obtuse angle Φ1.

### INDUSTRIAL APPLICABILITY

As noted above, the present disclosure relates to covers for hammer tools, and systems, assemblies, and methods thereof.

According to one or more embodiments, a cover for a hammer tool and systems, assemblies, and methods thereof can be flexible and can comprise a body; a first attachment interface at a first end portion of the body; and a second attachment interface at a second end portion of the body opposite the first end portion of the body. A predefined hinge can be formed in the body of the cover, between the first attachment interface and the second attachment interface. The cover can be configured to be fixedly coupled to a housing of a hammer tool via the first attachment interface. The flexible cover can be configured to be removably coupled to the housing of the hammer tool via the second attachment interface.

For instance, embodiments of the disclosed subject matter can involve a flexible cover for multiple variants of a hammer tool. The bottom of the cover can include two holes to fasten the cover onto a housing plate of the hammer tool. The cover can include a live hinge above the two holes allowing the cover to bend with ease while opening and closing a pocket of the hammer tool. The live hinge of the cover may be considered free from friction and rust, for instance, which may otherwise be caused from the harsh mining environment. The cover may have a progressive “V” styling and provide a positive holding experience that can encourage proper gripping because of a handle. The handle can include internal depressions or indentations for sleek robust usage. The cover can include peripheral snap features that may be distributed in such a way that positive locking is ensured. The positive locking of the cover may also be ensured by interferences, such as tabs, to engage the part of the housing that defines an aperture or opening into the pocket. As a result, the cover can be easily opened by hand, without tools, for access to the hammer tool interior and, thereafter, can be easily closed by hand, without tools, to securely seal off the hammer tool interior. The cover can include one or more bent portions at different locations, at different angles, and thereby provide one or more corresponding defined bend zones. The bend zone(s) of the cover can be defined to have stress free shape change for different hammer tool variants, i.e., one cover shape can be used with differently sized apertures. The cover can further include an extended snap feature. The extended snap feature can ensure positive locking, maintain necessary clearances, and/or ensure live hinge functionality of the cover. A plurality of ribs may be implemented to ensure that the cover is strong, light weight, and maintains suitable flexibility for multiple bends (including multiple openings and closing of the cover over the aperture into the pocket).

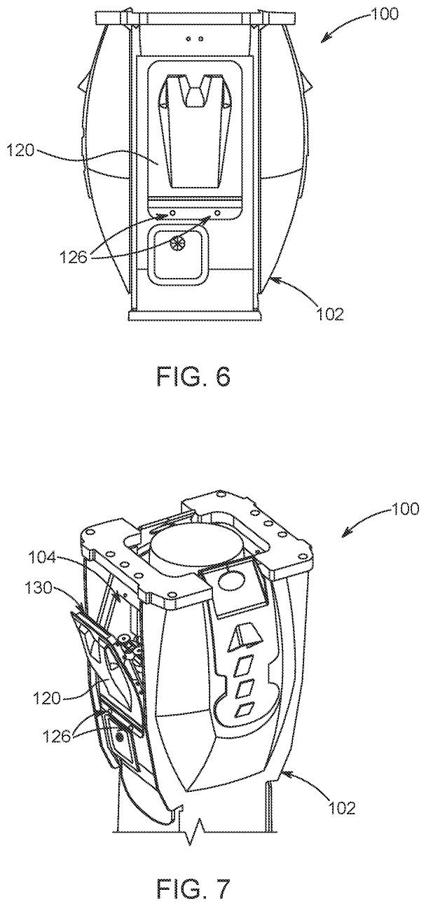

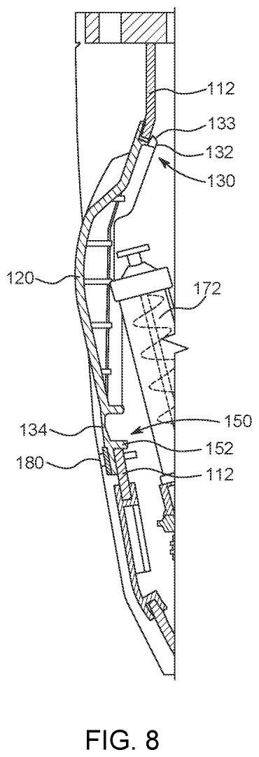

Turning now to FIG. 6, FIG. 7, and FIG. 8 relative to the above-discussed exemplary cover 120, these figures respectively show open and closed states of the cover 120 relative to the aperture 104.

Notably, FIG. 6 and FIG. 8 show a closed state of the cover 120, whereby the cover 120 fully covers the aperture 104, and is particularly fixedly and removably coupled to the housing 102 via at least the first attachment interface 126 and the second attachment interface 130, respectively. In the closed state the cover 120 may prevent access to inside the housing 102 via the aperture 104.

FIG. 7, on the other hand, shows the cover 120 in an open state. In the open state the cover 120 can be fixedly coupled to the housing 102 via the first attachment interface 126. However, the cover 120 may not be removably coupled to the housing 102. Rather, the portion of the cover 120 above the hinge 134 may be rotated away from the housing 102 and the aperture 104 to allow access to inside the housing 102 via the aperture. Thus, in some respects, the cover 120 may be characterized as or otherwise considered to act as an access door to inside the housing 102 via the aperture 104. According to one or more embodiments, the cover 120 may also be in an open state when completely removed from the housing, such as in FIG. 2.

It is noted that though FIG. 7 shows the cover 120 being opened from a top side, embodiments of the disclosed subject matter are not so limited. Rather, the cover 120 and the housing 102 may be configured such that the opening of the cover 120 is from the bottom. That is, the first attachment interface 126 may be provided above the second attachment interface 130. Likewise, embodiments of the disclosed subject matter are not limited to so-called vertical arrangements and may also include horizontal arrangements where the cover 120 can be opened from one side or the other.

Referring to FIG. 8, when the cover 120 is fixedly and removably coupled to the first panel 112, a portion of the cover 120 may be external to the first panel 112 and a portion of the cover 120 may be inside of the first panel 112. In particular, the flange 132 may be inside of the first panel 112, for instance, such that a corresponding edge of the first panel 112 that defines the aperture 104 is engaged by the tab 133. Additionally, the flange 150 may be inside of the first panel 112, for instance, such that a corresponding edge of the first panel 112 that defines the aperture 104 is engaged by the ridge 152. This can help prevent worksite dust and debris from entering the aperture 104.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations cannot be combined. Even though particular combinations of features are recited in the claims and/or disclosed in the specification, these combinations are not intended to limit the disclosure of various implementations. Although each dependent claim listed below may directly depend on only one claim, the disclosure of various implementations includes each dependent claim in combination with every other claim in the claim set.

While aspects of the present disclosure have been particularly shown and described with reference to the embodiments above, it will be understood by those skilled in the art that various additional embodiments may be contemplated by the modification of the disclosed machines, assemblies, systems, and methods without departing from the spirit and scope of what is disclosed. Such embodiments should be understood to fall within the scope of the present disclosure as determined based upon the claims and any equivalents thereof.

As used herein, “a” and “an” are intended to include one or more items, and may be used interchangeably with “one or more.” Further, as used herein, the article “the” is intended to include one or more items referenced in connection with the article “the” and may be used interchangeably with “the one or more.” Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A hammer tool assembly comprising:
a housing having an aperture to access an interior of the housing; and
a flexible, non-metallic cover configured to be fixedly and removably coupled to the housing, over the aperture of the housing, to prevent access to the interior of the housing in a closed state of the cover and to allow access to the interior of the housing in one or more open states of the cover,
wherein the cover includes:
a body having, in a front elevational view, a top edge, a bottom edge opposite the top edge in a length direction of the body, a left edge, and a right edge opposite the left edge in a width direction of the body perpendicular to the length direction, the top, bottom, left, and right edges forming a periphery of the body in the front elevational view,
a first attachment interface to fixedly couple to the housing a first end portion of the body associated with the bottom edge of the body,
a second attachment interface to removably couple to the housing a second end portion of the body opposite the first end portion of the body, associated with the top edge of the body,
a grip provided on a front side of the body, the grip having a convex portion and being offset on top, bottom, left, and right sides relative to the periphery of the body defined by the top, bottom, left, and right edges of the body in the front elevational view of the body, and
a hinge built into the body between the grip and the first attachment interface,
wherein the grip is between the hinge and the top edge of the body,
wherein the grip has a length in the length direction of the body greater than a width thereof in the width direction of the body, and
wherein the grip includes a pair of indentations formed in the convex portion, the indentations being spaced apart from each other in the width direction of the body.

2. The hammer tool assembly according to claim 1, wherein the first attachment interface includes one or more openings to receive respective one or more fasteners to fixedly couple the first end portion of the body to the housing.

3. The hammer tool assembly according to claim 1, wherein the second attachment interface includes a flange that projects from a rear side of the body opposite the front side of the body and is configured to removably couple the second end portion of body to the housing according to a snap-fit positive locking arrangement.

4. The hammer tool assembly according to claim 1, further comprising a projection extending from a rear side of the body opposite the front side of the body and configured to retain the body over the aperture to fixedly couple the first attachment interface to the housing to fixedly couple the first end portion of the 10 body of the housing.

5. (canceled)

6. The hammer tool assembly according to claim 1, wherein the hinge extends in the width direction from the left edge of the body to the right edge of the body opposite the left edge.

7. The hammer tool assembly according to claim 1, wherein in a side elevational view the body is curved.

8. The hammer tool assembly according to claim 7, wherein in the side elevational view the body has one or more bent portions, each of the one or more bent portions being bent at an obtuse angle relative to another portion of the body.

9. The hammer tool assembly according to claim 8,
wherein the one or more bent portions of the body includes a plurality of bent portions of the body,
wherein the hinge is one of the plurality of bent portions, and
wherein another of the plurality of bent portions is associated with bending recesses provided on a rear side of the body and separating the second attachment interface from a third attachment interface that is provided between the second attachment interface and the first attachment interface.

10. A flexible cover for a breaker tool comprising:
first coupling means for fixedly coupling a first end portion of the flexible cover to a housing of the breaker tool;
second coupling means for removably coupling a second end portion of the flexible cover to the housing of the breaker tool;
gripping means for manually gripping the flexible cover when the flexible cover is provided over an access opening in the housing of the breaker tool; and
moving means for moving a second portion of the flexible cover relative to a first portion of the flexible cover,
wherein the first portion of the flexible cover includes the first end portion of the flexible cover,
wherein a first periphery of gripping means in a front elevational view of the flexible cover is spaced from a second periphery of the flexible cover in the front elevational view of the flexible cover, the second periphery surrounding the first periphery in the front elevational view of the flexible cover,
wherein the gripping means has a convex portion and a pair of opposing indentations in opposite sidewalls of the convex portion, the indentations being spaced apart from each other in a width direction of the flexible cover,
wherein the gripping means is between the moving means and a second end of the flexible cover associated with the second end portion in a length direction of the flexible cover, and
wherein the convex portion of the gripping means has a portion that tapers from thick to thin toward a first end of the flexible cover opposite the second end in the front elevational view of the flexible cover.

11. The flexible cover according to claim 10, wherein the moving means is a living hinge formed in a body of the flexible cover that extends from a first edge of the body of the flexible cover to a second edge of the body of the flexible cover opposite the first edge.

12. The flexible cover according to claim 10, wherein the first coupling means includes:
a positive mounting interface to receive one or more fasteners to fixedly couple the first end portion of the flexible cover to the housing, and
the one or more fasteners to fixedly couple the first end portion of the flexible cover to the housing.

13. The flexible cover according to claim 10, further comprising flexing means for predefined flexing of the flexible cover,
wherein the flexing means includes a bent portion that is bent in a side elevational view of the flexible cover in an unflexed state of the flexible cover, the bent portion being bent at an obtuse angle, and
wherein the moving means for rotating the second portion of the flexible cover relative to the first portion of the flexible cover is separate from the means for predefined flexing.

14. (canceled)

15. A flexible cover for a hammer tool comprising:
a body;
a first attachment interface at a first end portion of the body; and
a second attachment interface at a second end portion of the body separated from the first end portion of the body,
wherein a predefined hinge is formed in the body between the first attachment interface and the second attachment interface,
wherein the flexible cover is configured to be fixedly coupled to a housing of the hammer tool via the first attachment interface,
wherein the flexible cover is configured to be removably coupled to the housing of the hammer tool via the second attachment interface,
wherein a grip is formed in the body, all of the grip being between a first end of the body associated with the first end portion and a second end of the body associated with the second end portion and opposite the first end of the body in a length direction of the body,
wherein the grip includes a convex portion that has at least two indentations formed in opposing sidewalls of the convex portion, the at least two indentations being spaced from each other in a width direction of the body perpendicular to the length direction of the body,
wherein the grip is between the second end of the body and the predefined hinge in the length direction of the body,
wherein the convex portion of the grip has a length in the length direction greater than a width thereof in the width direction, and
wherein the convex portion of the grip has a portion that tapers from thick to thin toward the first end portion of the body.

16. The flexible cover according to claim 15,
wherein the body has one or more bent portions in a side elevational view of the flexible cover, each of the one or more bent portions being bent at an obtuse angle, and
wherein the one or more bent portions are bent in an unflexed state of the flexible cover.

17. The flexible cover according to claim 15, wherein the grip is on a first side of the flexible cover and is hollow and concave on a second side of the flexible cover opposite the first side of the flexible cover.

18. The flexible cover according to claim 15, further comprising a locking projection extending from the body at a second side of the flexible cover, the locking projection being provided from the first end portion of the body and configured to hold the flexible cover in place when coupling the flexible cover to the housing.

19. The flexible cover according to claim 15,
wherein the second attachment interface includes one or more flanges extending from the body on a second side of the flexible cover, and
wherein at least one of the one or more flanges includes at least one snap-fit features provided on an outer sidewall thereof.

20. The flexible cover according to claim 19, further comprising a plurality of bending recesses provided on the second side of the flexible cover,
wherein each of the one or more flanges includes an associated first flange and an associated second flange, and
wherein each of the bending recesses separates the associated first flange from the associated second flange.

21. The flexible cover according to claim 10, wherein, in the front elevational view of the flexible cover, the flexible cover is free of any through holes between the second end of the flexible cover and the moving means.

22. The flexible cover according to claim 15, wherein, in the front elevational view of the flexible cover, the flexible cover is free of any through holes between the second end of the flexible cover and the predefined hinge.
